(19) United States
(12) Patent Application Publication
(10) Pub. No.: US 2026/0270994 A1
(43) Pub. Date: Sep. 10, 2026

(54) SCHEDULING AND RELAYING ENHANCEMENTS FOR NR DOWNLINK-BASED BACKSCATTER COMMUNICATIONS

(71) Applicant: QUALCOMM Incorporated, San Diego, CA (US)

(72) Inventors: Kangqi LIU, San Diego, CA (US); Chao WEI, Beijing (CN); Mingxi YIN, Beijing (CN); Min HUANG, Beijing (CN); Rui HU, Beijing (CN); Hao XU, Beijing (CN)

(21) Appl. No.: 18/881,207

(22) PCT Filed: Aug. 19, 2022
(86) PCT No.: PCT/CN2022/113520

§ 371 Date: Jan. 3, 2025

(51) Int. Cl. H04W 72/20; H04L 1/1812; H04W 28/02; H04W 72/0446; H04W 72/0453; H04W 72/12

(52) U.S. Cl. CPC H04W 72/20; H04L 1/1812; H04W 28/0278; H04W 72/0446; H04W 72/0453; H04W 72/12

(57) ABSTRACT

Certain aspects of the present disclosure provide techniques for scheduling and relaying enhancements for new radio (NR) downlink-based backscatter communications. An example method includes receiving control information from a network entity, the control information including: scheduling information for one or more data channel transmissions and configuration information for one or more backscatter transmissions, by a second wireless communication device, corresponding to the one or more data channel transmissions. The method also includes receiving the one or more data channel transmissions from the network entity based on the scheduling information and receiving the one or more backscatter transmissions from the second wireless communication device.

### BACKGROUND

### Field of the Disclosure

Aspects of the present disclosure relate to wireless communications, and more particularly, to techniques for scheduling and relaying enhancements for new radio (NR) downlink-based backscatter communications.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a first wireless communication device. The method includes receiving control information from a network entity, the control information including: scheduling information for one or more data channel transmissions and configuration information for one or more backscatter transmissions, by a second wireless communication device, corresponding to the one or more data channel transmissions; receiving the one or more data channel transmissions from the network entity based on the scheduling information; and receiving the one or more backscatter transmissions from the second wireless communication device.

Another aspect provides a method for wireless communication by a second wireless communication device. The method includes receiving control information from a network entity, wherein the control information includes configuration information for one or more backscatter transmissions by the second wireless communication device; receiving one or more data channel transmissions from the network entity; modulating the one or more data channel transmissions based on the configuration information to generate the one or more backscatter transmissions; and transmitting, after modulating the one or more data channel transmissions, the one or more backscatter transmissions to a first wireless communication device.

Another aspect provides a method for wireless communication by a network entity. The method includes transmitting control information to a first wireless communication device and a second wireless communication device, wherein the control information includes: scheduling information for one or more data channel transmissions and configuration information for one or more backscatter transmissions by a second wireless communication device; and transmitting, based on the scheduling information, the one or more data channel transmissions to the first wireless communication device and the second wireless communication device.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a radio frequency identification (RFID) system.

FIG. 6 illustrates an example topographies for circuitry of an RFID reader and for the energy harvesting circuitry.

FIG. 7 illustrates a wireless network including a network entity, a first communication device, and a second communication device.

FIG. 8 depicts a process flow illustrating operations for communications in a network.

FIGS. 9A and 9B illustrate different modulating techniques.

FIG. 10 depicts a method for wireless communications.

FIG. 11 depicts a method for wireless communications.

FIG. 12 depicts a method for wireless communications.

FIG. 13 depicts aspects of an example communications device.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for scheduling and relaying enhancements for new radio (NR) downlink-based backscatter communications.

In some cases, certain devices known as passive internet of things (PIOT) devices may be capable of harvesting energy from one or more wireless energy sources, such as RF signals, thermal energy, solar energy, etc. In some cases, when RF signals are used to harvest energy, a first device, such as an RF source device, may transmit an energy signal to a second device, such as a PIOT device. The second device may then harvest energy from the energy signal (e.g., using energy harvesting circuitry) and use this harvested energy to power one or more other components of the second device. After a sufficient amount of energy is accumulated, the second device may begin to modulate the energy signal with transmission bits and transmit the energy signal, known as a backscatter signal or backscatter communication, back to the first device (e.g., in the case where the RF source device is collocated with a reader device) or a third device (e.g., a non-collocated reader device).

In some cases, PIOT devices may coexist in a wireless network with other, more-advanced types of devices, such as fourth generation (4G) long term evolution (LTE)-based devices and fifth generation (5G) NR-based devices, which may not operate based on energy signals. As such, when communicating within the environment, a network entity may be required to transmit different types of signals to the 4G LTE/5G NR devices and the PIOT devices, which consumes a significant amount of time-frequency within the wireless network and power resources at the network entity. Additionally, the different types of signals may interfere with each other, which can cause some of the signals to not be properly received by at least one of the 4G LTE/5G NR devices or the PIOT devices. When signals are not properly received, the network entity may unnecessarily need to consume additional time, frequency, and power resources retransmitting the improperly received signals. Power resources may also be unnecessarily consumed at the 4G LTE/5G NR devices and the PIOT devices.

Accordingly, aspects of the present disclosure provide techniques for improving NR downlink-based backscatter communications to avoid the issues described above. For example, in some cases, to avoid having to transmit different types of signals to different types of devices within the wireless network, the techniques presented herein may involve using signals, such as data transmissions, transmitted by the network entity to a 4G LTE/5G NR device to additionally power a PIOT device. In such cases, the PIOT device may receive and harvest energy from these data transmissions. Thereafter, the PIOT device may (re) modulate the data transmissions (e.g., with information intended for the network entity) to generate one or more backscatter transmissions, which may be reflected/transmitted to the 4G LTE/5G NR device. The 4G LTE/5G NR device may then relay information received in the one or more backscatter transmissions to the network entity.

By re-using the data transmissions to power the PIOT device as well as to convey intended information to the 4G LTE/5G NR device, the amount of time-frequency resources consumed in the network, as well as power resources in the network entity, may be reduced. Moreover, re-using the data transmissions may help to avoid interference and retransmissions of improperly received signals, thereby further reducing the unnecessary consumption of time-frequency resources within the network and power resources in the network entity, the 4G LTE/5G NR device, and the PIOT device.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

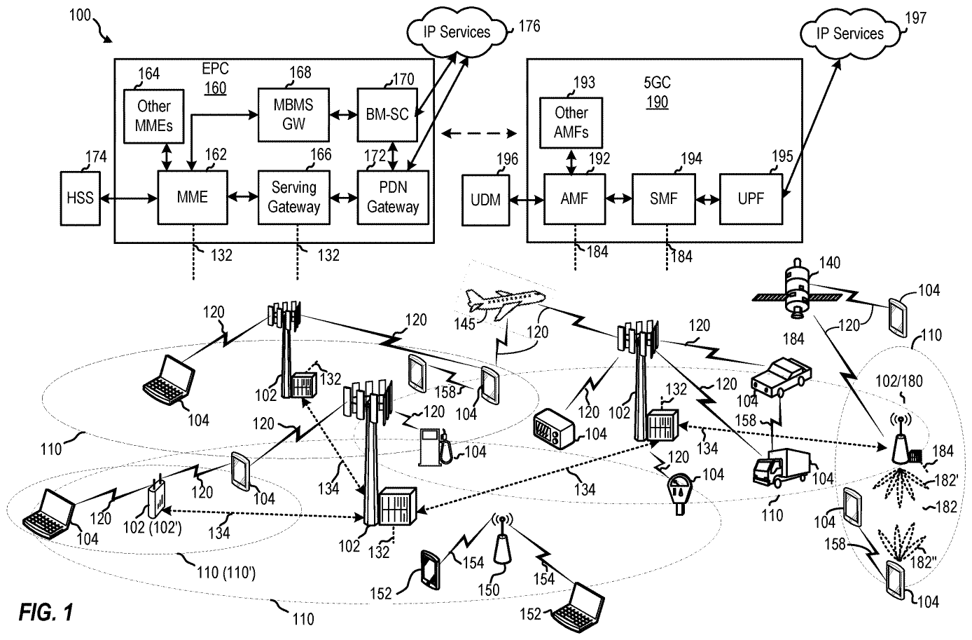

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

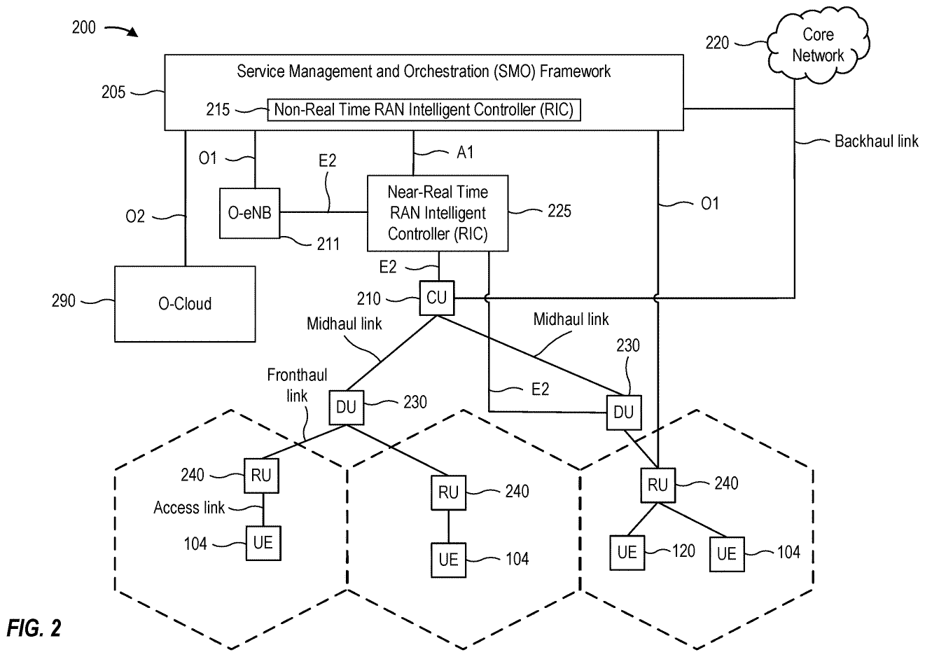

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

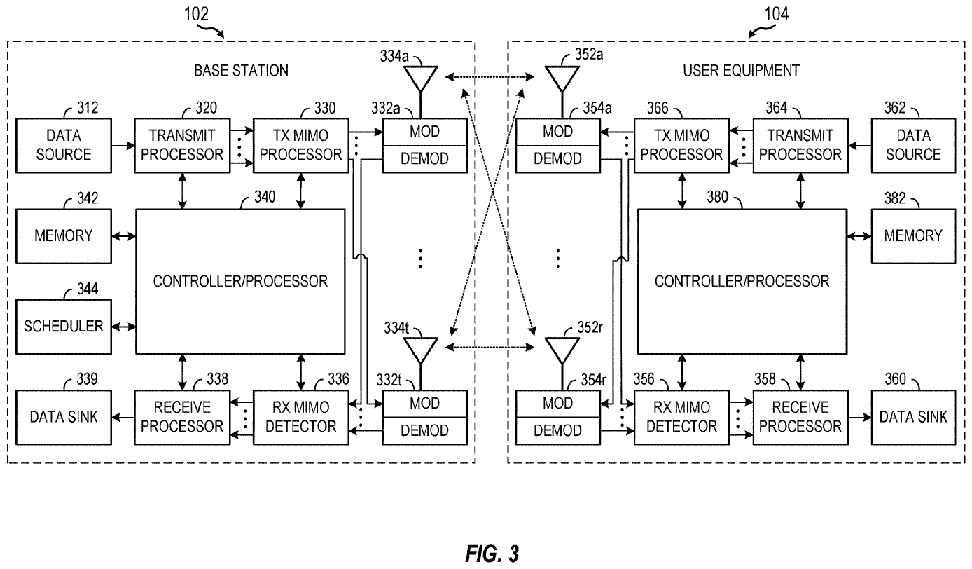

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

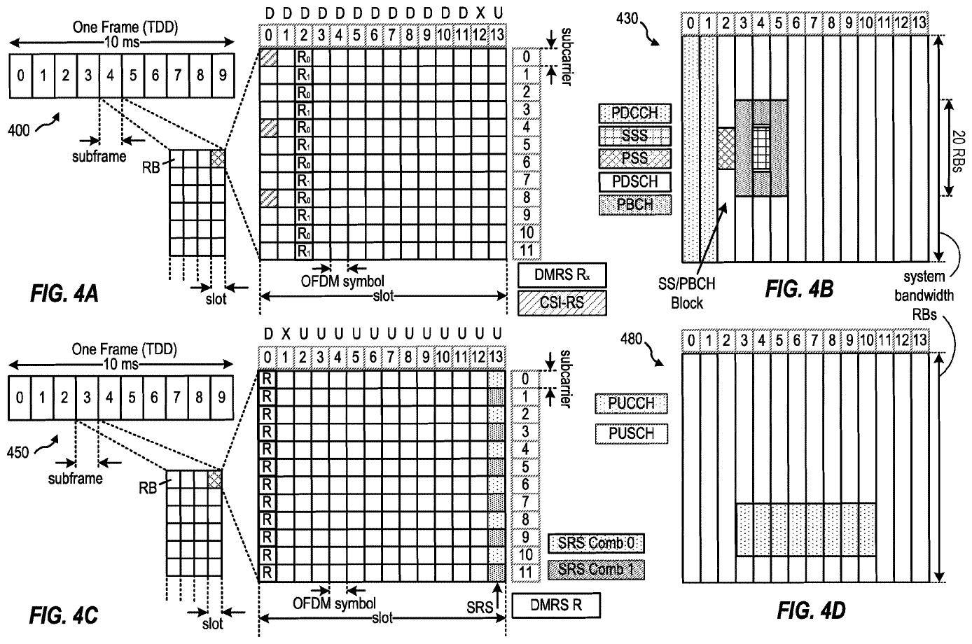

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in Radio Frequency Identification Systems

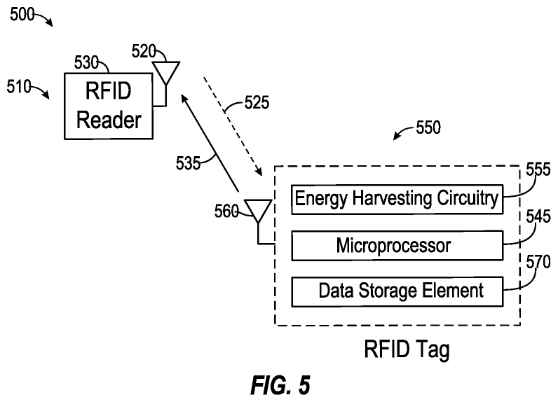

FIG. 5 shows a radio frequency identification (RFID) system 500. As shown, the RFID system 500 includes an RFID reader 510 and an RFID tag 550. The RFID reader 510 may also be referred to as an interrogator or a scanner. The RFID tag 550 may also be referred to as an RFID label or an electronics label.

The RFID reader 510 includes an antenna 520 and an electronics unit 530. The antenna 520 radiates signals transmitted by the RFID reader 510 and receives signals from RFID tags and/or other devices. The electronics unit 530 may include a transmitter and a receiver for reading RFID tags such as the RFID tag 550. The same pair of transmitter and receiver (or another pair of transmitter and receiver) may support bi-directional communication with wireless networks, wireless devices, etc. The electronics unit 530 may include processing circuitry (e.g., a processor) to perform processing for data being transmitted and received by the RFID reader 510.

As shown, the RFID tag 550 includes an antenna 560 and a data storage element 570. The antenna 560 radiates signals transmitted by the RFID tag 550 and receives signals from the RFID reader 510 and/or other devices. The data storage element 570 stores information for the RFID tag 550, for example, in an electrically erasable programmable read-only memory (EEPROM) or another type of memory. The RFID tag 550 may also include an electronics unit that can process the received signal and generate the signals to be transmitted. The RFID tag 550 may be a passive RFID tag having no battery. In this case, induction may be used to power the RFID tag 550. For example, in some cases, a magnetic field from a signal transmitted by RFID reader 510 may induce an electrical current in RFID tag 550, which may then operate based on the induced current. The RFID tag 550 can radiate its signal in response to receiving a signal from the RFID reader 510 or some other device.

In one example, the RFID tag 550 may be read by placing the RFID reader 510 within close proximity to the RFID tag 550. The RFID reader 510 may radiate a first signal 525 via the antenna 520. In some cases, the first signal 525 may be known as an interrogation signal or energy signal. In some cases, energy of the first signal 525 may be coupled from the RFID reader antenna 520 to RFID tag antenna 560 via magnetic coupling and/or other phenomena. In other words, the RFID tag 550 may receive the first signal 525 from RFID reader 510 via antenna 560 and energy of the first signal 525 may be harvested using energy harvesting circuitry 555 and used to power the RFID tag 550.

For example, energy of the first signal 525 received by the RFID tag 550 may be used to power a microprocessor 545 of the RFID tag 550. The microprocessor 545 may, in turn, retrieve information stored in a data storage element 570 of the RFID tag 550 and transmit the retrieved information via a second signal 535 using the antenna 560. For example, in some cases, the microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to the RFID reader 510. The RFID reader 510 may receive the second signal 535 from the RFID tag 550 via antenna 520 and may process (e.g., demodulate) the received signal to obtain the information of the data storage element 570 sent in the second signal 535.

In some cases, the RFID system 500 may be designed to operate at 13.56 MHz or some other frequency (e.g., an ultra-high frequency (UHF) band at 900 MHz). The RFID reader 510 may have a specified maximum transmit power level, which may be imposed by the Federal Communication Commission (FCC) in the United Stated or other regulatory bodies in other countries. The specified maximum transmit power level of the RFID reader 510 may limit the distance at which RFID tag 550 can be read by RFID reader 510.

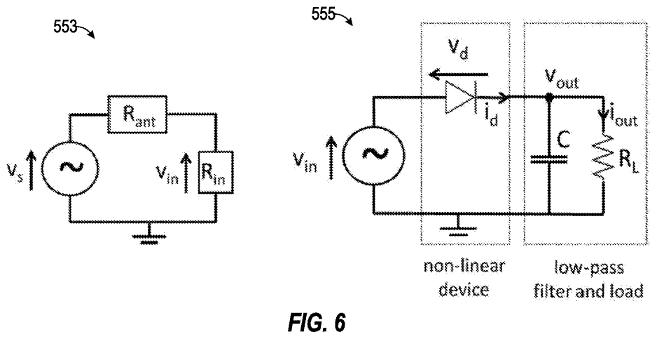

FIG. 6 illustrates an example equivalent circuit 553 of the antenna 560 of and an example topography of the energy harvesting circuitry 555 of the RFID tag 550. In some cases, as illustrated in the equivalent circuit 553 of the antenna 560, a lossless antenna may be modelled as an alternating current (AC) voltage source (νₛ(t)) followed by a series antenna resistance (Rₐₙₜ) of the antenna 560. In some cases, the voltage source (νₛ(t)) may be based on an energy signal y_{rf}(t)) received from the RFID reader 510. The equivalent circuit 553 of the antenna 560 also includes an input resistance (Rᵢₙ) representing a resistance associated with the energy harvesting circuitry 555. In some cases, with perfect impedance matching, Rᵢₙ may equal Rₐₙₜ.

As shown, the energy harvesting circuitry 555 comprises a half-wave rectifier circuit configured to convert an AC input power (νᵢₙ) (e.g., received via the antenna 560) into a direct current (DC) output power (νₒᵤₜ). Further, as shown, the energy harvesting circuitry 555 comprises a diode, a capacitor (C), and a load impedance (R_{L}). The diode is configured to pass only one half of each complete sine wave of the AC voltage in order to convert it into the DC voltage. Further, as illustrated in the energy harvesting circuitry 555 in FIG. 6, i_{d} is a current of the diode and v_{d} is a voltage of the diode. In some cases, under perfect matching, vᵢₙ(t) may be half of vₛ(t) and both can be related to the received signal energy signal (y_{rf}(t)) at the energy harvesting circuitry 555 as

$${v}_{s} ( t ) = 2 {y}_{rf} ( t ) {R}_{ant}^{\frac{1}{2}} and {v}_{i n} ( t ) = {y}_{rf} ( t ) {R}_{ant}^{\frac{1}{2}} .$$

### Aspects Related to Scheduling and Relaying Enhancements for NR Downlink-Based Backscatter Communications

Wireless technology is increasingly useful in industrial applications, such as ultra-reliable low-latency communication (URLLC) and machine type communication (MTC). In such domains, and others, it is desirable to support devices that are capable of harvesting energy from alternative energy sources (e.g., in lieu of or in combination with a battery or other energy storage device, such as a capacitor). For example, in some cases, these devices may not include a local power storage component and may instead harvest energy from wireless energy sources such as RF signals, thermal energy, solar energy, etc.

Such devices may, in some cases, be known as passive internet of things (PIOT) devices. In general, a communication range associated with PIOT-based communication may extend up to approximately 30 meters. Additionally, power consumption associated with PIOT communication may be very low, such as less than 0.1 milliwatts (mW) in order to support communication without a power storage device. PIOT devices may be relatively low cost (e.g., less than 2 cents) and have a positioning accuracy ranging between 3-5 meters.

PIOT devices may have different use cases. For example, one PIOT use case includes an industrial sensor use case where replacing batteries of communication devices is prohibitively difficult or undesirable (e.g., for safety monitoring or fault detection in smart factories, infrastructures, or environments). Another PIOT use case includes a smart logistics/warehousing use case in which extremely-low cost, small size, maintenance-free, durable, long lifespan communication devices are used, for example, for performing automated asset management in factories. Another PIOT use case includes a smart home network for household item management, wearables, and environment monitoring (e.g., a wearable device for medical monitoring where that does not require battery replacement).

As noted above, PIOT devices may be capable of harvesting energy from one or more wireless energy sources, such as RF signals, thermal energy, solar energy, etc. In some cases, when RF signals are used to harvest energy, a first device (e.g., BS 102, a disaggregated BS as described with respect to FIG. 2, UE 104, or any other device described herein capable of transmitting wireless signals) may transmit an energy signal to a second device, such as a PIOT device (e.g., UE 104, RFID tag 550, etc.). The second device may then harvest energy from the energy signal (e.g., using energy harvesting circuitry) and use this harvested energy to power one or more other components of the second device. In some cases, a portion of the harvested energy may be used to charge a local energy storage device of the second device for later use (i.e., the harvested energy may be stored in the local power storage component). After a sufficient amount of energy is accumulated, the second device may begin to reflect the energy signal radiated onto the second device, known as a backscatter signal or backscatter communication. When reflecting the energy signal, the second device may modulate a particular on-off pattern, corresponding to a set of transmission bits, onto the energy signal. The first device or a third device, known as a reader device, detects and demodulates the reflected pattern, thereby obtaining the set of transmission bits.

In some cases, PIOT devices may coexist in a wireless network with other types of devices, such as fourth generation (4G) long term evolution (LTE)-based devices and fifth generation (5G) new radio (NR)-based devices, which may not operate based on energy signals. As such, when communicating within the environment, a network entity may be required to transmit different types of signals to the 4G LTE/5G NR devices and the PIOT devices (e.g., the energy signals). In addition to the consuming time-frequency within the wireless network and power resources at the network entity transmitting the different types of signals to the 4G LTE/5G NR devices and the PIOT devices, the different types of signals transmitted to the 4G LTE/5G NR devices and the PIOT devices have the potential to interfere with each other, which is undesirable. For example, this interference may cause some of the signals to not be properly received by a least one of the 4G LTE/5G NR devices or the PIOT devices, requiring the network entity to unnecessarily consume additional time, frequency, and power resources retransmitting the improperly received signals.

Accordingly, aspects of the present disclosure provide techniques for improving NR downlink-based backscatter communications to avoid the issues described above. In some cases, these techniques may include scheduling and relaying enhancements for the NR downlink-based backscatter communications. For example, in some cases, to avoid having to transmit different types of signals to different types of devices within the wireless network, the techniques presented herein may involve using signals, such as data transmissions, transmitted by a network entity to a 4G LTE/5G NR device to additionally power a PIOT device. In other words, in addition to carrying data for the 4G LTE/5G NR device, the data transmissions may be used to power the PIOT device. In such cases, the PIOT device may receive and harvest energy from these data transmissions. Thereafter, the PIOT device may modulate (using the harvested energy) the data transmissions (e.g., with information intended for the network entity) to generate one or more backscatter transmissions, which may be reflected/transmitted to the 4G LTE/5G NR device. The 4G LTE/5G NR device may then relay information received in the one or more backscatter transmissions to the network entity.

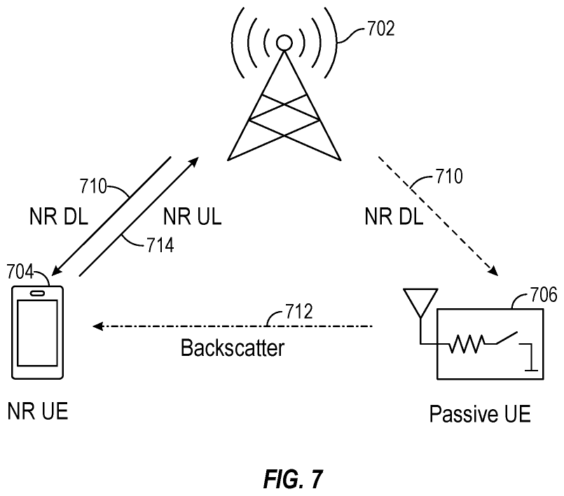

An example of these techniques is illustrated in FIG. 7. For example, FIG. 7 illustrates a wireless network 700 including a network entity 702, a first communication device 704 and a second communication device 706. In some cases, the network entity 702 may be an example of the BS 102 of FIGS. 1 and 3 or a disaggregated base station described with respect to FIG. 2. In some cases, the first communication device is an example of a UE 104 of FIGS. 1 and 3 and may be capable of advanced communications, such as 4G LTE communications, 5G NR communications, or communications according to subsequent wireless standards. In some cases, the second communication device may be an example of a PIOT device, such as the UE 104 of FIGS. 1 and 3 or the RFID tag 550.

As described above, in some cases, the network entity 702 may transmit one or more data transmissions 710 to the first communication device 704. The one or more data transmissions 710 transmitted to the first communication device 704 may also be received by the second communication device 706. Thereafter, the second communication device 706 may harvest energy from the one or more data transmissions 710. The second communication device 706 may then use the harvested energy to modulate the one or more data transmissions 710 (e.g., with information intended for the network entity 702) to generate one or more backscatter transmissions 712. The second communication device 706 then transmits the one or more backscatter transmissions 712 to the first communication device 704. Thereafter, the first communication device 604 transmits one or more uplink transmissions 714 to the network entity 702, including information obtained from the one or more backscatter transmissions 712. Additional aspects related to these techniques are described below.

### Example Operations of Entities in a Communications Network

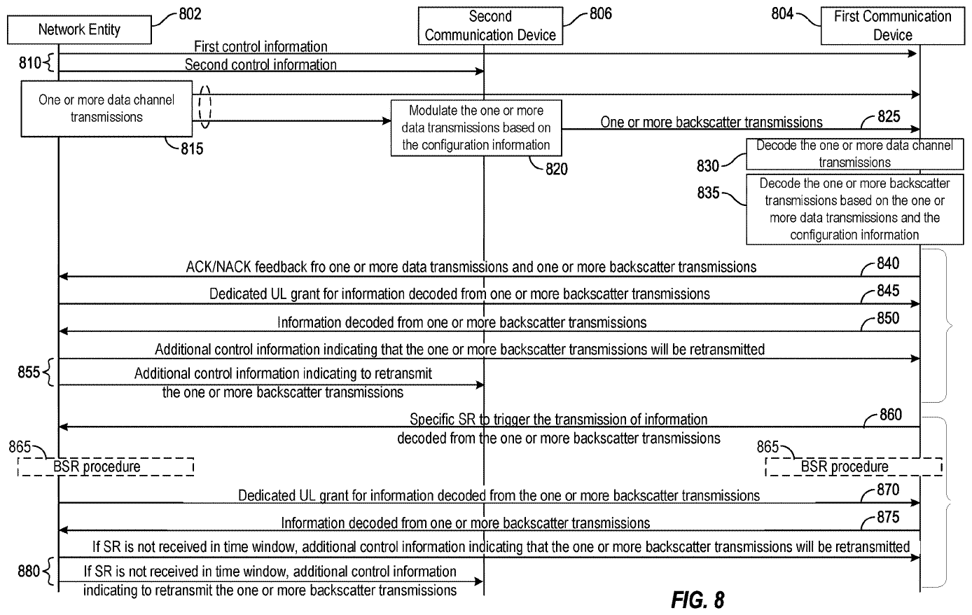

FIG. 8 depicts a process flow illustrating operations 800 for communications in a network between a network entity 802, a first communications device 804 and a second communications device 806. In some aspects, the network entity 802 may be an example of the BS 102 depicted and described with respect to FIGS. 1 and 3 or a disaggregated base station depicted and described with respect to FIG. 2. In some aspects, the first communications device 804 may be an example of UE 104 depicted and described with respect to FIGS. 1 and 3. In some aspects, the second communications device 806 may be a PIOT device, such as UE 104 depicted and described with respect to FIGS. 1 and 3 or the RFID tag 550 depicted and described with respect to FIG. 5. However, in other aspects, UE 104 may be another type of wireless communications device and BS 102 may be another type of network entity or network node, such as those described herein.

As shown, operations 800 begin in step 810 with the network entity 802 transmitting first control information to the first communications device 804 and transmitting second control information to the second communications device 806. In some cases, the first control information received by the first communications device 804 may include legacy control information, such as scheduling information for one or more data channel transmissions. In some cases, the first control information further includes configuration information for one or more backscatter transmissions, by the second communications device 806, corresponding to the one or more data channel transmissions. Additionally, in some cases, the second control information received by the second communication device may also include the configuration information for one or more backscatter transmissions, by the second communications device 806, corresponding to the one or more data channel transmissions.

In some cases, the scheduling information and configuration information for the one or more backscatter transmissions may be transmitted by the network entity in one control message or two separate control messages, such as a downlink control information (DCI) message, a media access control-control element (MAC-CE) message, and/or a radio resource control (RRC) message. In some cases, the configuration information for the one or more backscatter transmissions may include at least one of a modulation type of the one or more backscatter transmissions, a modulation order of the one or more backscatter transmissions, a frequency domain resource allocation (FDRA) for receiving the one or more backscatter transmissions, a time domain resource allocation (TDRA) for receiving the one or more backscatter transmissions, or a square wave frequency of the one or more backscatter transmissions.

Thereafter, as shown in step 815, the network entity 802 transmits, based on the scheduling information provided by the network entity 802 in the first control information transmitted in step 810, the one or more data channel transmissions to the first wireless communication device and the second wireless communication device. In some cases, the one or more data channel transmissions may be received by the first communications device 804 and the second communications device 806 in a first set of frequency resources. In some cases, the one or more data channel transmissions may comprise physical downlink shared channel (PDSCH) transmissions including data intended for the first communications device 804.

In some cases, the second communications device 806 receives the one or more data channel transmissions as ambient transmissions. In other words, the one or more data channel transmissions are intended for transmission to the first communications device 804 (e.g., the one or more data channel transmission include the data indented for the first communications device 804), but may also be received by the second communications device 806. In such cases, the second communications device 806 may harvest energy from the one or more data channel transmissions and use the energy harvested from the one or more data channel transmissions to perform modulation of the one or more data channel transmissions and transmission of one or more backscatter transmissions.

For example, as shown in step 820, the second communications device 806 modulates the one or more data channel transmissions based on the configuration information (e.g., modulation type, modulation order, FDRA, TDRA, square wave frequency, etc.) to generate the one or more backscatter transmissions. In some cases, modulating the one or more data channel transmissions may include adding additional information to the one or more data channel transmissions. As a result, the one or more backscatter transmissions comprise information included in the one or more data channel transmissions by the network entity 802 as well as the additional information added, based on the modulation, by the second communications device 806. In some cases, the additional information may include information, that is requested by the network entity 802, stored in an information storage element of the second communications device 806, such as information stored in the data storage element 570 shown in FIG. 5.

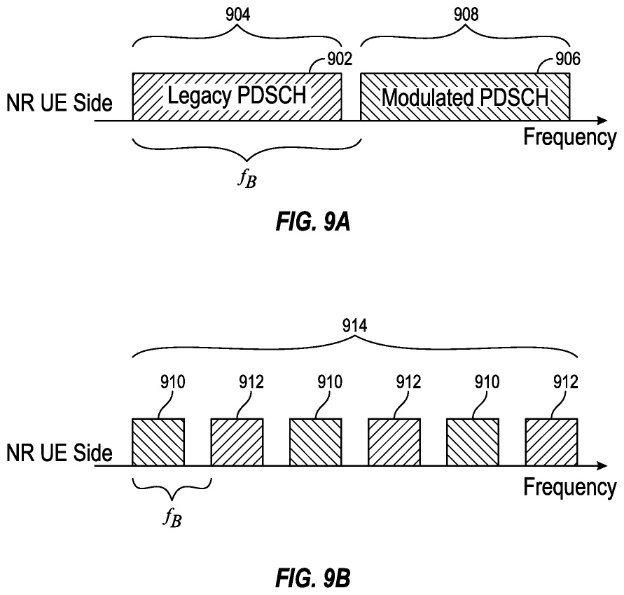

In some cases, modulating the one or more data channel transmissions in step 820 may include modulating the one or more data channel transmissions based on a different carrier frequency than the one or more data channel transmissions received from the network entity 802. For example, as illustrated in FIG. 9A, a legacy PDSCH 902 (e.g., the one or more data channel transmissions) may be modulated on a first frequency band 904 while a modulated PDSCH 906 (e.g., the one or more backscatter transmissions) may be modulated on a second frequency band 908. In some cases, a carrier frequency for the one or more backscatter transmissions (e.g., f_{b}) may be a multiple of 180 kilohertz (kHz).

In other cases, modulating the one or more data channel transmissions in step 820 may include modulating the one or more data channel transmissions using a same frequency band as the one or more data channel transmissions received from the network entity 802. For example, as illustrated in FIG. 9B, a legacy PDSCH 910 (e.g., the one or more data channel transmissions) and a modulated PDSCH 912 (e.g., the one or more backscatter transmissions) may be transmitted in a same frequency band 914. In such cases, as shown, the legacy PDSCH 910 and modulated PDSCH 912 may be transmitted using different subcarriers within the frequency band 914. For example, when transmitted using a same frequency band 914 as the legacy PDSCH 910, a carrier frequency (e.g., f_{b}) may be a multiple of 15 kHz.

In some cases, the second communications device 806 may modulate the one or more data channel transmissions received from the network entity 802 in different manners. For example, in some cases, the second communications device 806 may use a combination of phase shift keying (PSK) and frequency division multiplexing (FDM) to modulate the one or more data channel transmissions and to transmit the one or more backscatter transmissions. In such cases, modulating the one or more data channel transmissions in step 820 may be based on a carrier frequency and a set of phase offsets indicated in the second control information received in step 810. For example, the second communications device 806 may use a square wave with a carrier frequency f_{B} and a phase offset

$${φ}_{B} ∈ \{ 0 , \frac{2 π}{{2}^{m}} , … , \frac{2 π \cdot ( {2}^{m} - 2 )}{{2}^{m}} , \frac{2 π \cdot ( {2}^{m} - 1 )}{{2}^{m}} \}$$

to modulate the one or more data channel transmissions, where f_{B}=15·x kHz is a pre-configured frequency, m is a pre-configured modulation order, and m-bit(s) are modulated into each phase offset φ_{B}.

In some cases, the second communications device 806 may use a combination of amplitude shift keying (ASK) and FDM to modulate the one or more data channel transmissions and to transmit the one or more backscatter transmissions. In this case, modulating the one or more data channel transmissions in step 820 may be based on a carrier frequency and an amplitude sequence indicated in the second control information in step 810. For example, the second communications device 806 may The passive UE will use a square wave with a frequency f_{B} and an amplitude sequence {s₀, S₁, . . . , S₂_{^{m}}₋₁} to modulate the received NR data, where f_{B}=15·x kHz is a pre-configured frequency (e.g., indicated in the configuration information), m is a pre-configured modulation order, and m-bit(s) may be modulated into an amplitude sequence.

Thereafter, as shown in step 825, the second communications device 806 transmits, after modulating the one or more data channel transmissions, the one or more backscatter transmissions to the first communications device 804. In some cases, the first communications device 804 may receive the one or more backscatter transmissions in a second set of frequency resources, different from the first set of frequency resources in which the one or more data channel transmissions were received, as described above.

As shown in step 830, the first communications device 804 may decode the one or more data channel transmissions received from network entity 802 in step 815. As shown in step 835, the first communications device 804 may also decode the one or more backscatter transmissions received from the second communications device 806. In some cases, the first communications device 804 may decode the one or more backscatter transmissions based on the one or more data channel transmissions and the configuration information for the one or more backscatter transmissions (e.g., modulation type, modulation order, FDRA, TDRA, square wave frequency, etc.) to obtain the additional information intended for the network entity added by the second communications device 806. For example, the first communications device 804 may use the already-decoded one or more data channel transmissions to assist in decoding the one or more backscatter transmissions.

After decoding the one or more backscatter transmissions, the first communications device 804 may transmit feedback information to the network entity 802 for the one or more data channel transmissions and for the one or more backscatter transmissions (e.g., to send the additional information intended for the network entity 802 received from the second communications device 806). In some cases, the feedback information may be transmitted by the first communications device 804 using different options.

A first option for transmitting the feedback information is illustrated in steps 840-855 in FIG. 8 and involves transmitting an explicit acknowledgement (ACK) or negative acknowledgement (NACK) for the one or more backscatter transmissions received from the second communications device 806. In some cases, an ACK may trigger the network entity 802 to transmit an UL grant with resources for transmitting the additional information from the one or more backscatter transmissions without the first communications device 804 having to transmit a scheduling request (SR) or perform a buffer status report (BSR) procedure. In some cases, a NACK may cause the network entity 802 to trigger retransmission of the one or more backscatter transmissions by the second communications device 806, for example, by retransmitting the one or more data channel transmissions to the second communications device 806.

More specifically, for example, as illustrated in step 840 of FIG. 8, in response to decoding the one or more data channel transmissions and the one or more backscatter transmissions, the first communications device 804 transmits feedback information (e.g., ACK/NACK feedback) to the network entity 802 for the one or more data channel transmissions and the one or more backscatter transmissions. In some cases, the feedback information comprises a joint hybrid automatic repeat request acknowledgement (HARQ-ACK) codebook, including feedback information for both the one or more data channel transmissions and the one or more backscatter transmissions. In some cases, the feedback information comprises (1) a first HARQ-ACK codebook comprising first feedback information for the one or more data channel transmissions and (2) a second HARQ-ACK codebook comprising second feedback information for the one or more backscatter transmissions.

In some cases, the feedback information transmitted in step 840 may include positive feedback (e.g., ACK feedback) indicating that the one or more backscatter transmissions were properly received by the first communications device 804, the network entity 802 transmits a dedicated UL grant to the first communications device 804. In some cases, the dedicated UL grant allocates time and frequency resources for transmitting the additional information decoded from the one or more backscatter transmissions to the network entity 802. In some cases, the first communications device 804 may receive the dedicated UL grant without first transmitting an SR or a BSR to request the time and frequency resources for transmitting the additional information decoded from the one or more backscatter transmissions. Thereafter, in step 850 of FIG. 8, in response to receiving the dedicated UL grant, the first communications device 804 transmits the information decoded from the one or more backscatter transmissions to the network entity 802 using the allocated time and frequency resources.

In some cases, the feedback information for the one or more backscatter transmissions comprises negative feedback information (e.g., NACK feedback), indicating that the one or more backscatter transmissions were not properly received by the first communications device 804. In this case, as shown in step 855 based on the negative feedback information, the network entity 802 may transmit additional control information to the first communications device 804 indicating that the one or more backscatter transmissions will be retransmitted by the second wireless communication device. Similarly, as shown in step 855, the network entity 802 transmits additional control information to the second communications device 806 indicating to the second communications device 806 to retransmit the one or more backscatter transmissions.

Thereafter, while not illustrated in FIG. 8, the network entity 802 may retransmit, based on the additional control information transmitted to the first communications device 804 and the second communications device 806, the one or more data channel transmissions to at least the second communications device 806. The first communications device 804 may then receive the one or more backscatter transmission retransmitted by the second communications device 806 based on the additional control information and the retransmitted one or more data channel transmissions. The first communications device 804 may then take action to transmit the additional information decoded from the one or more backscatter transmissions to the network entity 802.

A second option for transmitting the feedback information is illustrated in steps 860-880 in FIG. 8 and involves implicitly indicating acknowledgement information (e.g., ACK or NACK) for the one or more backscatter transmissions received from the second communications device 806. For example, an ACK associated with the one or more backscatter transmissions may be implicitly indicated or inferred by using a specific SR that requests time and frequency resources for transmitting the additional information decoded from the one or more backscatter transmissions. In other words, the first communications device 804 may implicitly indicate that the one or more backscatter transmissions were properly received and decoded by transmitting the specific SR to the network entity 802, which requests the time and frequency resources for transmitting the additional information decoded from the one or more backscatter transmissions.

Accordingly, for example, as shown in step 860 in FIG. 8, in response to decoding the one or more data channel transmissions and the one or more backscatter transmissions, the first communications device 804 transmits an SR to the network entity 82 to request time and frequency resources for transmitting the additional information decoded from the one or more backscatter transmissions to the network entity 802.

In step 865 in FIG. 8, the network entity 802 and first communications device 804 may optionally perform a BSR procedure in which the first communications device 804 reports, to the network entity 802, an amount of data stored in a transmission buffer of the first communications device 804 associated with the additional information decoded from the one or more backscatter transmissions. In some cases, if the network entity 802 knows (e.g., ahead of time) a buffer status of the additional information decoded from the one or more backscatter transmissions (e.g., the amount of data associated with the additional information), the BSR procedure may be skipped.

Thereafter, as illustrated in step 870 in FIG. 8, the network entity 802 transmits a dedicated UL grant to the first communications device 804, allocating time and frequency resources for transmitting the additional information decoded from the one or more backscatter transmissions to the network entity 802. In some cases, the time and frequency resources allocated in the dedicated UL grant may only be used for transmitting the additional information decoded from the one or more backscatter transmissions. In some cases, the network entity 802 may determine the time and frequency resources and transmit the dedicated UL grant based on the BSR procedure and the amount of data reported to the network entity 802. In other cases, the network entity 802 may determine the time and frequency resources and transmit the dedicated UL grant based on amount of data known ahead of time (e.g., without performing the BSR procedure).

Thereafter, as illustrated in step 875 in FIG. 8, the first communications device 804 transmits the information decoded from the one or more backscatter transmissions to the network entity 802 using the allocated time and frequency resources indicated in the dedicated UL grant.

In some cases, when the one or more backscatter transmissions are not properly received or decoded, a NACK associated with the one or more backscatter transmissions may be implicitly indicated or inferred when the network entity 802 fails to receive the specific SR within a time window associated with the transmission of the one or more data channel transmissions. In other words, the first communications device 804 may implicitly indicate that the one or more backscatter transmissions were not properly received or decoded by not transmitting the specific SR to the network entity 802 within the time window.

In such cases, based on a scheduling request not being transmitted by the first communications device 804 within the time window associated with transmission of the one or more data channel transmissions, the first communications device 804 may receive additional control information from the network entity 802 in step 880 in FIG. 8 indicating that the one or more backscatter transmissions will be retransmitted by the second communications device 806. Additionally, in some cases, the network entity 802 may also transmit additional control information to the second communications device 806 indicating to retransmit the one or more backscatter transmissions. Thereafter, while not illustrated in FIG. 8, the network entity 802 may retransmit the one or more data channel transmissions to at least the second communications device 806 based on the additional control information. Thereafter, based on the retransmitted one or more data channel transmissions and the additional control information, the second communications device 806 may retransmit the one or more backscatter transmissions to the first communication device. The first communications device 804 may then take action to transmit the additional information decoded from the one or more backscatter transmissions to the network entity 802.

### Example Operations of a First Wireless Communications Device

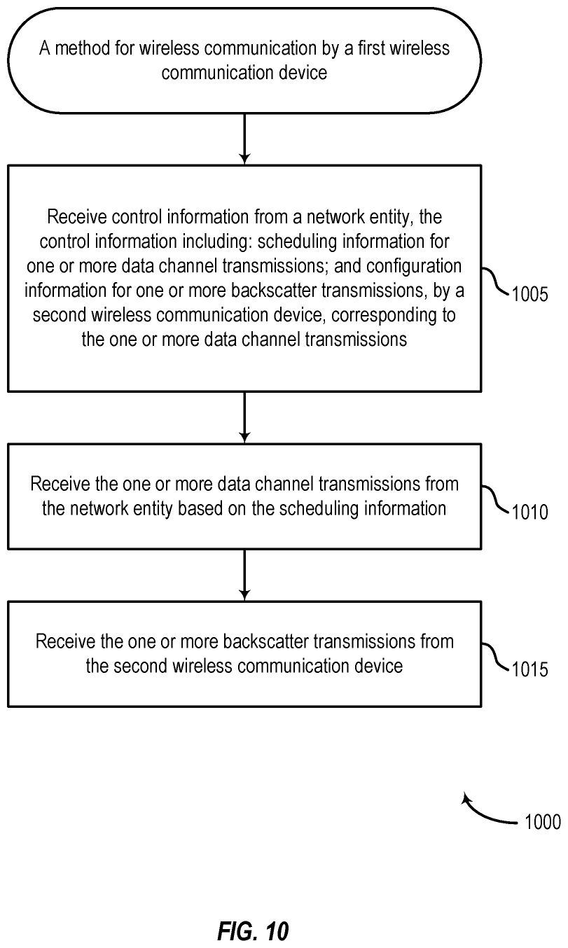

FIG. 10 shows an example of a method 1000 for wireless communication by a first wireless communication device. In some aspects, the first wireless communication device is user equipment, such as a UE 104 of FIGS. 1 and 3. In some cases, the first wireless communication device is capable of 4G LTE-based communication and/or 5G NR-based communication.

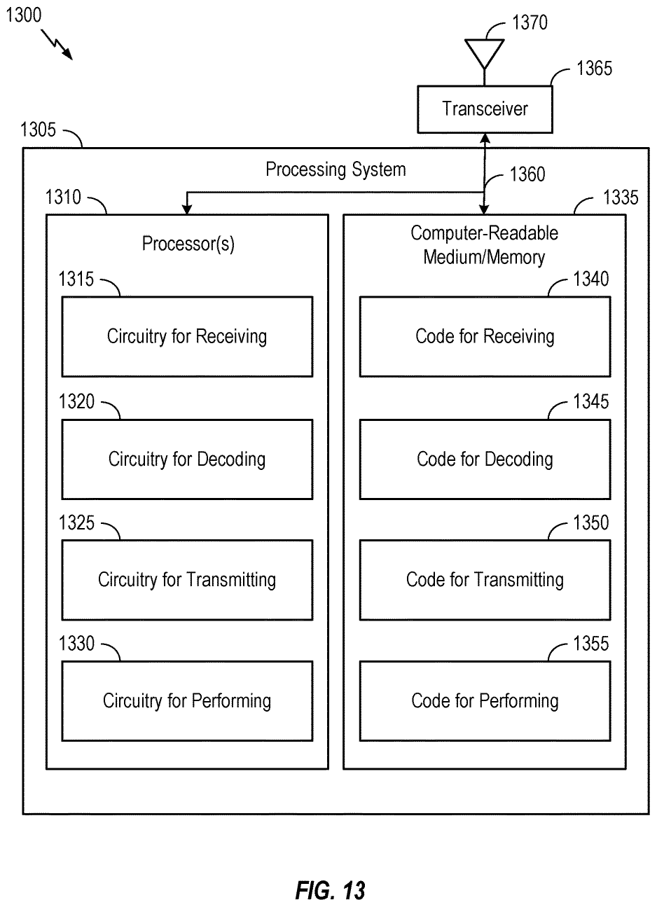

Method 1000 begins at step 1005 with receiving control information from a network entity, the control information including: scheduling information for one or more data channel transmissions and configuration information for one or more backscatter transmissions, by a second wireless communication device, corresponding to the one or more data channel transmissions. In some cases, the operations of this step refer to, or may be performed by, circuitry for receiving and/or code for receiving as described with reference to FIG. 13.

Method 1000 then proceeds to step 1010 with receiving the one or more data channel transmissions from the network entity based on the scheduling information. In some cases, the operations of this step refer to, or may be performed by, circuitry for receiving and/or code for receiving as described with reference to FIG. 13.

Method 1000 then proceeds to step 1015 with receiving the one or more backscatter transmissions from the second wireless communication device. In some cases, the operations of this step refer to, or may be performed by, circuitry for receiving and/or code for receiving as described with reference to FIG. 13.

In some aspects, the configuration information includes at least one of: a modulation type of the one or more backscatter transmissions, a modulation order of the one or more backscatter transmissions, a frequency domain resource allocation for receiving the one or more backscatter transmissions, a time domain resource allocation for receiving the one or more backscatter transmissions, or a square wave frequency of the one or more backscatter transmissions.

In some aspects, the one or more backscatter transmissions comprise information included in the one or more data channel transmissions the one or more backscatter transmissions are modulated to include additional information added by the second wireless communication device.

In some aspects, the one or more backscatter transmissions are modulated using a same frequency band as the one or more data channel transmissions.

In some aspects, the one or more backscatter transmissions are modulated using a different frequency band than the one or more data channel transmissions.

In some aspects, the one or more backscatter transmissions are modulated based on a carrier frequency and a set of phase offsets indicated in the configuration information.

In some aspects, the one or more backscatter transmissions are modulated based on a carrier frequency and an amplitude sequence indicated in the configuration information.

In some aspects, the method 1000 further includes decoding the one or more backscatter transmissions received from the second wireless communication device based on the one or more data channel transmissions and the configuration information for the one or more backscatter transmissions. In some cases, the operations of this step refer to, or may be performed by, circuitry for decoding and/or code for decoding as described with reference to FIG. 13.

In some aspects, the method 1000 further includes transmitting, to the network entity, feedback information for the one or more data channel transmissions and the one or more backscatter transmissions. In some cases, the operations of this step refer to, or may be performed by, circuitry for transmitting and/or code for transmitting as described with reference to FIG. 13.

In some aspects, the feedback information comprises a joint HARQ-ACK codebook, including feedback information for both the one or more data channel transmissions and the one or more backscatter transmissions.

In some aspects, the feedback information comprises: a first HARQ-ACK codebook comprising first feedback information for the one or more data channel transmissions; and a second HARQ-ACK codebook comprising second feedback information for the one or more backscatter transmissions.

In some aspects, the feedback information for the one or more backscatter transmissions comprises positive feedback information, indicating that the one or more backscatter transmissions were properly received by the first wireless communication device.

In some aspects, the method 1000 further includes receiving, from the network entity based on the positive feedback information, a grant allocating time and frequency resources for transmitting information decoded from the one or more backscatter transmissions to the network entity. In some cases, the operations of this step refer to, or may be performed by, circuitry for receiving and/or code for receiving as described with reference to FIG. 13.

In some aspects, the method 1000 further includes transmitting the information decoded from the one or more backscatter transmissions to the network entity using the allocated time and frequency resources. In some cases, the operations of this step refer to, or may be performed by, circuitry for transmitting and/or code for transmitting as described with reference to FIG. 13.

In some aspects, the grant allocating time and frequency resources is received without first transmitting a scheduling request or a buffer status report to request time and frequency resources for transmitting the information decoded from the one or more backscatter transmissions.

In some aspects, the feedback information for the one or more backscatter transmissions comprises negative feedback information, indicating that the one or more backscatter transmissions were not properly received by the first wireless communication device.

In some aspects, the method 1000 further includes receiving, based on the negative feedback information, additional control information indicating that the one or more backscatter transmissions will be retransmitted by the second wireless communication device. In some cases, the operations of this step refer to, or may be performed by, circuitry for receiving and/or code for receiving as described with reference to FIG. 13.

In some aspects, the method 1000 further includes receiving the one or more backscatter transmission retransmitted by the second wireless communication device based on the additional control information. In some cases, the operations of this step refer to, or may be performed by, circuitry for receiving and/or code for receiving as described with reference to FIG. 13.

In some aspects, the method 1000 further includes transmitting, based on receiving the one or more backscatter transmissions, a scheduling request to the network entity to request time and frequency resources for transmitting information decoded from the one or more backscatter transmissions to the network entity. In some cases, the operations of this step refer to, or may be performed by, circuitry for transmitting and/or code for transmitting as described with reference to FIG. 13.

In some aspects, the method 1000 further includes receiving, from the network entity based on the scheduling request, a grant allocating time and frequency resources for transmitting the information decoded from the one or more backscatter transmissions to the network entity. In some cases, the operations of this step refer to, or may be performed by, circuitry for receiving and/or code for receiving as described with reference to FIG. 13.

In some aspects, the method 1000 further includes transmitting the information decoded from the one or more backscatter transmissions to the network entity using the allocated time and frequency resources. In some cases, the operations of this step refer to, or may be performed by, circuitry for transmitting and/or code for transmitting as described with reference to FIG. 13.

In some aspects, the method 1000 further includes, based on transmitting the scheduling request, performing a BSR procedure to report, to the network entity, an amount of data stored in a transmission buffer of the first wireless communication device associated with the information decoded from the one or more backscatter transmissions, wherein receiving the grant allocating the time and frequency resources is further based on the BSR procedure and the amount of data reported to the network entity. In some cases, the operations of this step refer to, or may be performed by, circuitry for performing and/or code for performing as described with reference to FIG. 13.

In some aspects, the method 1000 further includes receiving, based on a scheduling request not being transmitted by the first wireless communication device within a time window associated with transmission of the one or more data channel transmissions, additional control information indicating that the one or more backscatter transmissions will be retransmitted by the second wireless communication device. In some cases, the operations of this step refer to, or may be performed by, circuitry for receiving and/or code for receiving as described with reference to FIG. 13.

In some aspects, the method 1000 further includes receiving the one or more backscatter transmissions retransmitted by the second wireless communication device based on the additional control information. In some cases, the operations of this step refer to, or may be performed by, circuitry for receiving and/or code for receiving as described with reference to FIG. 13.

In one aspect, method 1000, or any aspect related to it, may be performed by an apparatus, such as communications device 1300 of FIG. 13, which includes various components operable, configured, or adapted to perform the method 1000. Communications device 1300 is described below in further detail.

Note that FIG. 10 is just one example of a method, and other methods including fewer, additional, or alternative steps are possible consistent with this disclosure.

### Example Operations of a Second Wireless Communication Device

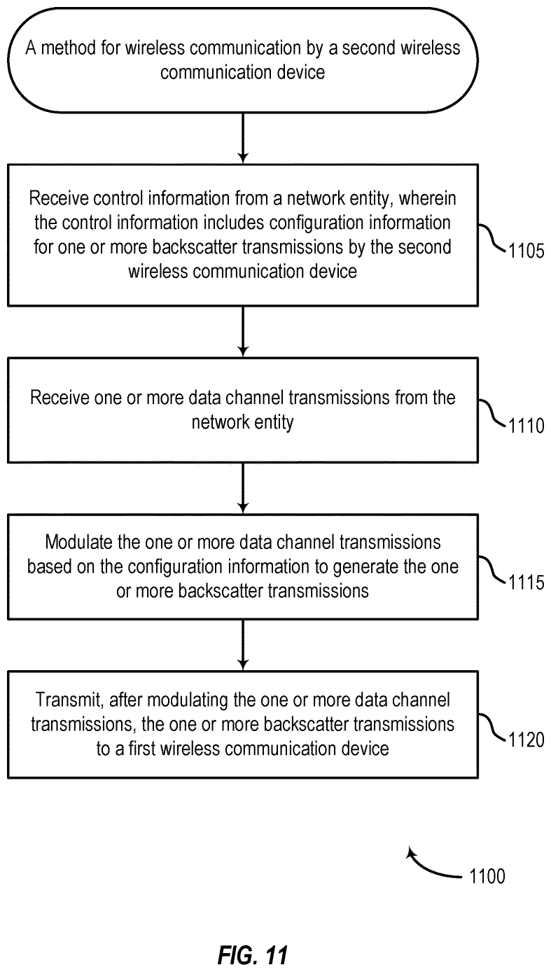

FIG. 11 shows an example of a method 1100 for wireless communication by a second wireless communication device. In some aspects, the second wireless communication device is a PIOT device, such as a UE 104 of FIGS. 1 and 3 or an RFID tag 550 of FIG. 5.

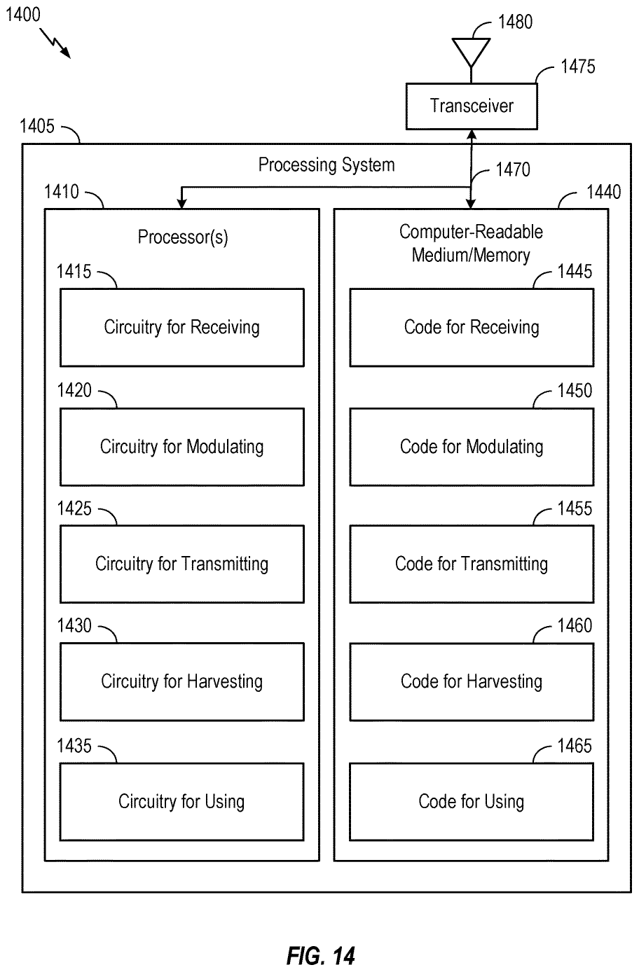

Method 1100 begins at step 1105 with receiving control information from a network entity, wherein the control information includes configuration information for one or more backscatter transmissions by the second wireless communication device. In some cases, the operations of this step refer to, or may be performed by, circuitry for receiving and/or code for receiving as described with reference to FIG. 14.

Method 1100 then proceeds to step 1110 with receiving one or more data channel transmissions from the network entity. In some cases, the operations of this step refer to, or may be performed by, circuitry for receiving and/or code for receiving as described with reference to FIG. 14.

Method 1100 then proceeds to step 1115 with modulating the one or more data channel transmissions based on the configuration information to generate the one or more backscatter transmissions. In some cases, the operations of this step refer to, or may be performed by, circuitry for modulating and/or code for modulating as described with reference to FIG. 14.

Method 1100 then proceeds to step 1120 with transmitting, after modulating the one or more data channel transmissions, the one or more backscatter transmissions to a first wireless communication device. In some cases, the operations of this step refer to, or may be performed by, circuitry for transmitting and/or code for transmitting as described with reference to FIG. 14.

In some aspects, the configuration information includes at least one of: a modulation type for the one or more backscatter transmissions, a modulation order for the one or more backscatter transmissions, a frequency domain resource allocation for transmitting the one or more backscatter transmissions, a time domain resource allocation for transmitting the one or more backscatter transmissions, or a square wave frequency for the one or more backscatter transmissions.

In some aspects, the one or more backscatter transmissions comprise information included in the one or more data channel transmissions by the network entity as well as additional information added, based on the modulation, by the second wireless communication device.

In some aspects, modulating the one or more data channel transmissions comprises modulating the one or more data channel transmissions using a same frequency band as the one or more data channel transmissions received from the network entity.

In some aspects, modulating the one or more data channel transmissions comprises modulating the one or more data channel transmissions using a different frequency than the one or more data channel transmissions received from the network entity.

In some aspects, modulating the one or more data channel transmissions comprises modulating the one or more data channel transmissions based on based on a carrier frequency and a set of phase offsets indicated in the configuration information.

In some aspects, modulating the one or more data channel transmissions comprises modulating the one or more data channel transmissions based on a carrier frequency and an amplitude sequence indicated in the configuration information.

In some aspects, the method 1100 further includes harvesting energy from the one or more data channel transmissions. In some cases, the operations of this step refer to, or may be performed by, circuitry for harvesting and/or code for harvesting as described with reference to FIG. 14.

In some aspects, the method 1100 further includes using the energy harvested from the one or more data channel transmissions to perform the modulating and the transmitting. In some cases, the operations of this step refer to, or may be performed by, circuitry for using and/or code for using as described with reference to FIG. 14.

In one aspect, method 1100, or any aspect related to it, may be performed by an apparatus, such as communications device 1400 of FIG. 14, which includes various components operable, configured, or adapted to perform the method 1100. Communications device 1400 is described below in further detail.

Note that FIG. 11 is just one example of a method, and other methods including fewer, additional, or alternative steps are possible consistent with this disclosure.

### Example Operations of a Network Entity

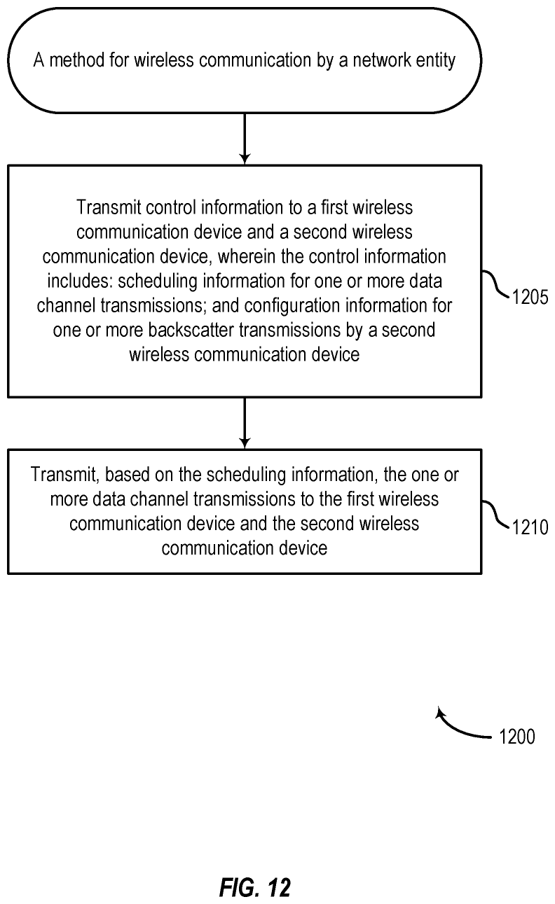

FIG. 12 shows an example of a method 1200 for wireless communication by a network entity, such as BS 102 of FIGS. 1 and 3, or a disaggregated base station as discussed with respect to FIG. 2.

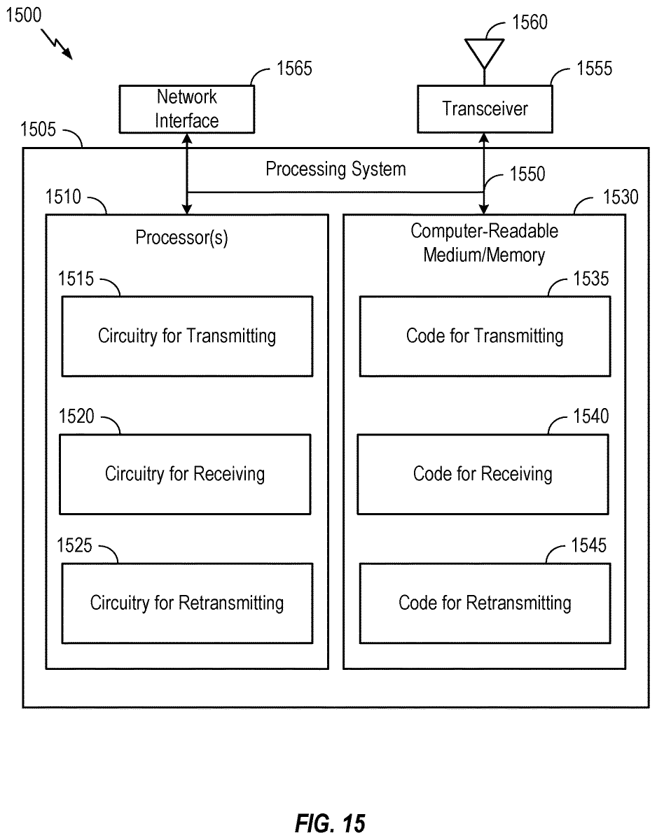

Method 1200 begins at step 1205 with transmitting control information to a first wireless communication device and a second wireless communication device, wherein the control information includes: scheduling information for one or more data channel transmissions and configuration information for one or more backscatter transmissions by a second wireless communication device. In some cases, the operations of this step refer to, or may be performed by, circuitry for transmitting and/or code for transmitting as described with reference to FIG. 15.

Method 1200 then proceeds to step 1210 with transmitting, based on the scheduling information, the one or more data channel transmissions to the first wireless communication device and the second wireless communication device. In some cases, the operations of this step refer to, or may be performed by, circuitry for transmitting and/or code for transmitting as described with reference to FIG. 15.

In some aspects, the configuration information includes at least one of: a modulation type of the one or more backscatter transmissions, a modulation order of the one or more backscatter transmissions, a frequency domain resource allocation for receiving the one or more backscatter transmissions, a time domain resource allocation for receiving the one or more backscatter transmissions, or a square wave frequency of the one or more backscatter transmissions.

In some aspects, the method 1200 further includes receiving, from the first wireless communication device, feedback information for the one or more data channel transmissions and the one or more backscatter transmissions. In some cases, the operations of this step refer to, or may be performed by, circuitry for receiving and/or code for receiving as described with reference to FIG. 15.

In some aspects, the feedback information comprises a joint HARQ-ACK codebook, including feedback information for both the one or more data channel transmissions and the one or more backscatter transmissions.

In some aspects, the feedback information comprises: a first HARQ-ACK codebook comprising first feedback information for the one or more data channel transmissions, and a second HARQ-ACK codebook comprising second feedback information for the one or more backscatter transmissions.

In some aspects, the feedback information for the one or more backscatter transmissions comprises positive feedback information, indicating that the one or more backscatter transmissions were properly received by the first wireless communication device.

In some aspects, the method 1200 further includes transmitting, to the first wireless communication device based on the positive feedback information, a grant allocating time and frequency resources for transmitting information decoded from the one or more backscatter transmissions to the network entity. In some cases, the operations of this step refer to, or may be performed by, circuitry for transmitting and/or code for transmitting as described with reference to FIG. 15.

In some aspects, the method 1200 further includes receiving the information decoded from the one or more backscatter transmissions from the first wireless communication device using the allocated time and frequency resources. In some cases, the operations of this step refer to, or may be performed by, circuitry for receiving and/or code for receiving as described with reference to FIG. 15.

In some aspects, the grant allocating time and frequency resources is transmitted without first receiving a scheduling request or a buffer status report requesting time and frequency resources for transmitting the information decoded from the one or more backscatter transmissions.

In some aspects, the feedback information for the one or more backscatter transmissions comprises negative feedback information, indicating that the one or more backscatter transmissions were not properly received by the first wireless communication device.

In some aspects, the method 1200 further includes transmitting, based on the negative feedback information, additional control information to the first wireless communication device indicating that the one or more backscatter transmissions will be retransmitted by the second wireless communication device. In some cases, the operations of this step refer to, or may be performed by, circuitry for transmitting and/or code for transmitting as described with reference to FIG. 15.

In some aspects, the method 1200 further includes retransmitting, based on the additional control information, the one or more data channel transmissions to at least the second wireless communication device. In some cases, the operations of this step refer to, or may be performed by, circuitry for retransmitting and/or code for retransmitting as described with reference to FIG. 15.

In some aspects, the method 1200 further includes receiving a scheduling request from the first wireless communication device requesting time and frequency resources for transmitting information decoded from the one or more backscatter transmissions to the network entity. In some cases, the operations of this step refer to, or may be performed by, circuitry for receiving and/or code for receiving as described with reference to FIG. 15.

In some aspects, the method 1200 further includes transmitting, to the first wireless communication device based on the scheduling request, a grant allocating time and frequency resources for transmitting the information decoded from the one or more backscatter transmissions to the network entity. In some cases, the operations of this step refer to, or may be performed by, circuitry for transmitting and/or code for transmitting as described with reference to FIG. 15.

In some aspects, the method 1200 further includes receiving the information decoded from the one or more backscatter transmissions from the first wireless communication device using the allocated time and frequency resources. In some cases, the operations of this step refer to, or may be performed by, circuitry for receiving and/or code for receiving as described with reference to FIG. 15.

In some aspects, the method 1200 further includes, based on receiving the scheduling request, receiving a BSR from the first wireless communication device indicating an amount of data stored in a transmission buffer of the first wireless communication device associated with the information decoded from the one or more backscatter transmissions, wherein transmitting the grant allocating the time and frequency resources is further based on the BSR. In some cases, the operations of this step refer to, or may be performed by, circuitry for receiving and/or code for receiving as described with reference to FIG. 15.

In some aspects, the method 1200 further includes transmitting, to the first wireless communication device based on a scheduling request not being received from the first wireless communication device within a time window associated transmission of the one or more data channel transmissions, additional control information indicating that the one or more backscatter transmissions will be retransmitted by the second wireless communication device. In some cases, the operations of this step refer to, or may be performed by, circuitry for transmitting and/or code for transmitting as described with reference to FIG. 15.

In some aspects, the method 1200 further includes retransmitting the one or more data channel transmissions to the second wireless communication device based on the additional control information. In some cases, the operations of this step refer to, or may be performed by, circuitry for retransmitting and/or code for retransmitting as described with reference to FIG. 15.

In one aspect, method 1200, or any aspect related to it, may be performed by an apparatus, such as communications device 1500 of FIG. 15, which includes various components operable, configured, or adapted to perform the method 1200. Communications device 1500 is described below in further detail.

Note that FIG. 12 is just one example of a method, and other methods including fewer, additional, or alternative steps are possible consistent with this disclosure.

### Example Communications Devices

FIG. 13 depicts aspects of an example communications device 1300. In some aspects, communications device 1300 is a user equipment, such as a UE 104 described above with respect to FIGS. 1 and 3.

The communications device 1300 includes a processing system 1305 coupled to the transceiver 1365 (e.g., a transmitter and/or a receiver). The transceiver 1365 is configured to transmit and receive signals for the communications device 1300 via the antenna 1370, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, cause the one or more processors 1310 to perform the method 1000 described with respect to FIG. 10, or any aspect related to it. Note that reference to a processor performing a function of communications device 1300 may include one or more processors 1310 performing that function of communications device 1300.

In the depicted example, computer-readable medium/memory 1335 stores code (e.g., executable instructions), such as code for receiving 1340, code for decoding 1345, code for transmitting 1350, and code for performing 1355. Processing of the code for receiving 1340, code for decoding 1345, code for transmitting 1350, and code for performing 1355 may cause the communications device 1300 to perform the method 1000 described with respect to FIG. 10, or any aspect related to it.

The one or more processors 1310 include circuitry configured to implement (e.g., execute) the code stored in the computer-readable medium/memory 1335, including circuitry such as circuitry for receiving 1315, circuitry for decoding 1320, circuitry for transmitting 1325, and circuitry for performing 1330. Processing with circuitry for receiving 1315, circuitry for decoding 1320, circuitry for transmitting 1325, and circuitry for performing 1330 may cause the communications device 1300 to perform the method 1000 described with respect to FIG. 10, or any aspect related to it.

Various components of the communications device 1300 may provide means for performing the method 1000 described with respect to FIG. 10, or any aspect related to it. For example, means for transmitting, sending or outputting for transmission may include transceivers 354 and/or antenna(s) 352 of the UE 104 illustrated in FIG. 3 and/or the transceiver 1365 and the antenna 1370 of the communications device 1300 in FIG. 13. Means for receiving or obtaining may include transceivers 354 and/or antenna(s) 352 of the UE 104 illustrated in FIG. 3 and/or the transceiver 1365 and the antenna 1370 of the communications device 1300 in FIG. 13.

FIG. 14 depicts aspects of an example communications device 1400. In some aspects, communications device 1400 is a RFID tag, such as a RFID tag 550 described above with respect to FIG. 5. In some aspects, communications device 1400 is a user equipment, such as UE 104 described above with respect to FIGS. 1 and 3.

The communications device 1400 includes a processing system 1405 coupled to the transceiver 1475 (e.g., a transmitter and/or a receiver). The transceiver 1475 is configured to transmit and receive signals for the communications device 1400 via the antenna 1480, such as the various signals as described herein. The processing system 1405 may be configured to perform processing functions for the communications device 1400, including processing signals received and/or to be transmitted by the communications device 1400.

The processing system 1405 includes one or more processors 1410. In various aspects, the one or more processors 1410 may be representative of one or more of receive processor 358, transmit processor 364, TX MIMO processor 366, and/or controller/processor 380, as described with respect to FIG. 3. The one or more processors 1410 are coupled to a computer-readable medium/memory 1440 via a bus 1470. In certain aspects, the computer-readable medium/memory 1440 is configured to store instructions (e.g., computer-executable code) that when executed by the one or more processors 1410, cause the one or more processors 1410 to perform the method 1100 described with respect to FIG. 11, or any aspect related to it. Note that reference to a processor performing a function of communications device 1400 may include one or more processors 1410 performing that function of communications device 1400.

In the depicted example, computer-readable medium/memory 1440 stores code (e.g., executable instructions), such as code for receiving 1445, code for modulating 1450, code for transmitting 1455, code for harvesting 1460, and code for using 1465. Processing of the code for receiving 1445, code for modulating 1450, code for transmitting 1455, code for harvesting 1460, and code for using 1465 may cause the communications device 1400 to perform the method 1100 described with respect to FIG. 11, or any aspect related to it.

The one or more processors 1410 include circuitry configured to implement (e.g., execute) the code stored in the computer-readable medium/memory 1440, including circuitry such as circuitry for receiving 1415, circuitry for modulating 1420, circuitry for transmitting 1425, circuitry for harvesting 1430, and circuitry for using 1435. Processing with circuitry for receiving 1415, circuitry for modulating 1420, circuitry for transmitting 1425, circuitry for harvesting 1430, and circuitry for using 1435 may cause the communications device 1400 to perform the method 1100 described with respect to FIG. 11, or any aspect related to it.

Various components of the communications device 1400 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1475 and the antenna 1480 of the communications device 1400 in FIG. 14. Means for receiving or obtaining may include transceivers 354 and/or antenna(s) 352 of the UE 104 illustrated in FIG. 3 and/or the transceiver 1475 and the antenna 1480 of the communications device 1400 in FIG. 14.

FIG. 15 depicts aspects of an example communications device 1500. In some aspects, communications device 1500 is a network entity, such as BS 102 of FIGS. 1 and 3, or a disaggregated base station as discussed with respect to FIG. 2.

The communications device 1500 includes a processing system 1505 coupled to the transceiver 1555 (e.g., a transmitter and/or a receiver) and/or a network interface 1565. The transceiver 1555 is configured to transmit and receive signals for the communications device 1500 via the antenna 1560, such as the various signals as described herein. The network interface 1565 is configured to obtain and send signals for the communications device 1500 via communication link(s), such as a backhaul link, midhaul link, and/or fronthaul link as described herein, such as with respect to FIG. 2. The processing system 1505 may be configured to perform processing functions for the communications device 1500, including processing signals received and/or to be transmitted by the communications device 1500.

The processing system 1505 includes one or more processors 1510. In various aspects, one or more processors 1510 may be representative of one or more of receive processor 338, transmit processor 320, TX MIMO processor 330, and/or controller/processor 340, as described with respect to FIG. 3. The one or more processors 1510 are coupled to a computer-readable medium/memory 1530 via a bus 1550. In certain aspects, the computer-readable medium/memory 1530 is configured to store instructions (e.g., computer-executable code) that when executed by the one or more processors 1510, cause the one or more processors 1510 to perform the method 1200 described with respect to FIG. 12, or any aspect related to it. Note that reference to a processor of communications device 1500 performing a function may include one or more processors 1510 of communications device 1500 performing that function.

In the depicted example, the computer-readable medium/memory 1530 stores code (e.g., executable instructions), such as code for transmitting 1535, code for receiving 1540, and code for retransmitting 1545. Processing of the code for transmitting 1535, code for receiving 1540, and code for retransmitting 1545 may cause the communications device 1500 to perform the method 1200 described with respect to FIG. 12, or any aspect related to it.

The one or more processors 1510 include circuitry configured to implement (e.g., execute) the code stored in the computer-readable medium/memory 1530, including circuitry such as circuitry for transmitting 1515, circuitry for receiving 1520, and circuitry for retransmitting 1525. Processing with circuitry for transmitting 1515, circuitry for receiving 1520, and circuitry for retransmitting 1525 may cause the communications device 1500 to perform the method 1200 as described with respect to FIG. 12, or any aspect related to it.

Various components of the communications device 1500 may provide means for performing the method 1200 as described with respect to FIG. 12, or any aspect related to it. Means for transmitting, sending or outputting for transmission may include transceivers 332 and/or antenna(s) 334 of the BS 102 illustrated in FIG. 3 and/or the transceiver 1555 and the antenna 1560 of the communications device 1500 in FIG. 15. Means for receiving or obtaining may include transceivers 332 and/or antenna(s) 334 of the BS 102 illustrated in FIG. 3 and/or the transceiver 1555 and the antenna 1560 of the communications device 1500 in FIG. 15.

### Example Clauses

Implementation examples are described in the following numbered clauses:

Clause 1: A method for wireless communication by a first wireless communication device, comprising: receiving control information from a network entity, the control information including: scheduling information for one or more data channel transmissions, and configuration information for one or more backscatter transmissions, by a second wireless communication device, corresponding to the one or more data channel transmissions; receiving the one or more data channel transmissions from the network entity based on the scheduling information; and receiving the one or more backscatter transmissions from the second wireless communication device.

Clause 2: The method of Clause 1, wherein the configuration information includes at least one of: a modulation type of the one or more backscatter transmissions, a modulation order of the one or more backscatter transmissions, a frequency domain resource allocation for receiving the one or more backscatter transmissions, a time domain resource allocation for receiving the one or more backscatter transmissions, or a square wave frequency of the one or more backscatter transmissions.

Clause 3: The method of any one of Clauses 1 and 2, wherein: the one or more backscatter transmissions comprise information included in the one or more data channel transmissions the one or more backscatter transmissions are modulated to include additional information added by the second wireless communication device.

Clause 4: The method of Clause 3, wherein the one or more backscatter transmissions are modulated based on a same carrier frequency as the one or more data channel transmissions.

Clause 5: The method of Clause 3, wherein the one or more backscatter transmissions are modulated based on a different carrier frequency than the one or more data channel transmissions.

Clause 6: The method of Clause 3, wherein the one or more backscatter transmissions are modulated based on a carrier frequency and a set of phase offsets indicated in the configuration information.

Clause 7: The method of Clause 3, wherein the one or more backscatter transmissions are modulated based on a carrier frequency and an amplitude sequence indicated in the configuration information.

Clause 8: The method of any one of Clauses 1-7, further comprising: decoding the one or more backscatter transmissions received from the second wireless communication device based on the one or more data channel transmissions and the configuration information for the one or more backscatter transmissions.

Clause 9: The method of any one of Clauses 1-8, further comprising: transmitting, to the network entity, feedback information for the one or more data channel transmissions and the one or more backscatter transmissions.

Clause 10: The method of Clause 9, wherein the feedback information comprises a joint HARQ-ACK codebook, including feedback information for both the one or more data channel transmissions and the one or more backscatter transmissions.

Clause 11: The method of Clause 9, wherein the feedback information comprises: a first HARQ-ACK codebook comprising first feedback information for the one or more data channel transmissions; and a second HARQ-ACK codebook comprising second feedback information for the one or more backscatter transmissions.

Clause 12: The method of Clause 9, wherein the feedback information for the one or more backscatter transmissions comprises positive feedback information, indicating that the one or more backscatter transmissions were properly received by the first wireless communication device.

Clause 13: The method of Clause 12, further comprising: receiving, from the network entity based on the positive feedback information, a grant allocating time and frequency resources for transmitting information decoded from the one or more backscatter transmissions to the network entity; and transmitting the information decoded from the one or more backscatter transmissions to the network entity using the allocated time and frequency resources.

Clause 14: The method of Clause 13, wherein the grant allocating time and frequency resources is received without first transmitting a scheduling request or a buffer status report to request time and frequency resources for transmitting the information decoded from the one or more backscatter transmissions.

Clause 15: The method of Clause 9, wherein the feedback information for the one or more backscatter transmissions comprises negative feedback information, indicating that the one or more backscatter transmissions were not properly received by the first wireless communication device.

Clause 16: The method of Clause 15, further comprising: receiving, based on the negative feedback information, additional control information indicating that the one or more backscatter transmissions will be retransmitted by the second wireless communication device; and receiving the one or more backscatter transmission retransmitted by the second wireless communication device based on the additional control information.

Clause 17: The method of any one of Clauses 1-16, further comprising: transmitting, based on receiving the one or more backscatter transmissions, a scheduling request to the network entity to request time and frequency resources for transmitting information decoded from the one or more backscatter transmissions to the network entity.

Clause 18: The method of Clause 17, further comprising: receiving, from the network entity based on the scheduling request, a grant allocating time and frequency resources for transmitting the information decoded from the one or more backscatter transmissions to the network entity; and transmitting the information decoded from the one or more backscatter transmissions to the network entity using the allocated time and frequency resources.

Clause 19: The method of Clause 18, further comprising, based on transmitting the scheduling request, performing a BSR procedure to report, to the network entity, an amount of data stored in a transmission buffer of the first wireless communication device associated with the information decoded from the one or more backscatter transmissions, wherein receiving the grant allocating the time and frequency resources is further based on the BSR procedure and the amount of data reported to the network entity.

Clause 20: The method of any one of Clauses 1-19, further comprising: receiving, based on a scheduling request not being transmitted by the first wireless communication device within a time window associated with transmission of the one or more data channel transmissions, additional control information indicating that the one or more backscatter transmissions will be retransmitted by the second wireless communication device; and receiving the one or more backscatter transmissions retransmitted by the second wireless communication device based on the additional control information.

Clause 21: A method for wireless communication by a second wireless communication device, comprising: receiving control information from a network entity, wherein the control information includes configuration information for one or more backscatter transmissions by the second wireless communication device; receiving one or more data channel transmissions from the network entity; modulating the one or more data channel transmissions based on the configuration information to generate the one or more backscatter transmissions; and transmitting, after modulating the one or more data channel transmissions, the one or more backscatter transmissions to a first wireless communication device.

Clause 22: The method of Clause 21, wherein the configuration information includes at least one of: a modulation type for the one or more backscatter transmissions, a modulation order for the one or more backscatter transmissions, a frequency domain resource allocation for transmitting the one or more backscatter transmissions, a time domain resource allocation for transmitting the one or more backscatter transmissions, or a square wave frequency for the one or more backscatter transmissions.

Clause 23: The method of any one of Clauses 21 and 22, wherein the one or more backscatter transmissions comprise information included in the one or more data channel transmissions by the network entity as well as additional information added, based on the modulation, by the second wireless communication device.

Clause 24: The method of any one of Clauses 21-23, wherein modulating the one or more data channel transmissions comprises modulating the one or more data channel transmissions based on a same carrier frequency as the one or more data channel transmissions received from the network entity.

Clause 25: The method of any one of Clauses 21-24, wherein modulating the one or more data channel transmissions comprises modulating the one or more data channel transmissions based on a different carrier frequency than the one or more data channel transmissions received from the network entity.

Clause 26: The method of any one of Clauses 21-25, wherein modulating the one or more data channel transmissions comprises modulating the one or more data channel transmissions based on based on a carrier frequency and a set of phase offsets indicated in the configuration information.

Clause 27: The method of any one of Clauses 21-26, wherein modulating the one or more data channel transmissions comprises modulating the one or more data channel transmissions based on a carrier frequency and an amplitude sequence indicated in the configuration information.

Clause 28: The method of any one of Clauses 21-27, further comprising: harvesting energy from the one or more data channel transmissions; and using the energy harvested from the one or more data channel transmissions to perform the modulating and the transmitting.

Clause 29: A method for wireless communication by a network entity, comprising: transmitting control information to a first wireless communication device and a second wireless communication device, wherein the control information includes: scheduling information for one or more data channel transmissions, and configuration information for one or more backscatter transmissions by a second wireless communication device; and transmitting, based on the scheduling information, the one or more data channel transmissions to the first wireless communication device and the second wireless communication device.

Clause 30: The method of Clause 29, wherein the configuration information includes at least one of: a modulation type of the one or more backscatter transmissions, a modulation order of the one or more backscatter transmissions, a frequency domain resource allocation for receiving the one or more backscatter transmissions, a time domain resource allocation for receiving the one or more backscatter transmissions, or a square wave frequency of the one or more backscatter transmissions.

Clause 31: The method of any one of Clauses 29 and 30, further comprising: receiving, from the first wireless communication device, feedback information for the one or more data channel transmissions and the one or more backscatter transmissions.

Clause 32: The method of Clause 31, wherein the feedback information comprises a joint HARQ-ACK codebook, including feedback information for both the one or more data channel transmissions and the one or more backscatter transmissions.

Clause 33: The method of Clause 31, wherein the feedback information comprises: a first HARQ-ACK codebook comprising first feedback information for the one or more data channel transmissions, and a second HARQ-ACK codebook comprising second feedback information for the one or more backscatter transmissions.

Clause 34: The method of Clause 31, wherein the feedback information for the one or more backscatter transmissions comprises positive feedback information, indicating that the one or more backscatter transmissions were properly received by the first wireless communication device.

Clause 35: The method of Clause 34, further comprising: transmitting, to the first wireless communication device based on the positive feedback information, a grant allocating time and frequency resources for transmitting information decoded from the one or more backscatter transmissions to the network entity; and receiving the information decoded from the one or more backscatter transmissions from the first wireless communication device using the allocated time and frequency resources.

Clause 36: The method of Clause 35, wherein the grant allocating time and frequency resources is transmitted without first receiving a scheduling request or a buffer status report requesting time and frequency resources for transmitting the information decoded from the one or more backscatter transmissions.

Clause 37: The method of Clause 31, wherein the feedback information for the one or more backscatter transmissions comprises negative feedback information, indicating that the one or more backscatter transmissions were not properly received by the first wireless communication device.

Clause 38: The method of Clause 37, further comprising: transmitting, based on the negative feedback information, additional control information to the first wireless communication device indicating that the one or more backscatter transmissions will be retransmitted by the second wireless communication device; and retransmitting, based on the additional control information, the one or more data channel transmissions to at least the second wireless communication device.

Clause 39: The method of any one of Clauses 29-38, further comprising: receiving a scheduling request from the first wireless communication device requesting time and frequency resources for transmitting information decoded from the one or more backscatter transmissions to the network entity.

Clause 40: The method of Clause 39, further comprising: transmitting, to the first wireless communication device based on the scheduling request, a grant allocating time and frequency resources for transmitting the information decoded from the one or more backscatter transmissions to the network entity; and receiving the information decoded from the one or more backscatter transmissions from the first wireless communication device using the allocated time and frequency resources.

Clause 41: The method of Clause 40, further comprising, based on receiving the scheduling request, receiving a BSR from the first wireless communication device indicating an amount of data stored in a transmission buffer of the first wireless communication device associated with the information decoded from the one or more backscatter transmissions, wherein transmitting the grant allocating the time and frequency resources is further based on the BSR.

Clause 42: The method of any one of Clauses 29-41, further comprising: transmitting, to the first wireless communication device based on a scheduling request not being received from the first wireless communication device within a time window associated transmission of the one or more data channel transmissions, additional control information indicating that the one or more backscatter transmissions will be retransmitted by the second wireless communication device; and retransmitting the one or more data channel transmissions to the second wireless communication device based on the additional control information.

Clause 43: An apparatus, comprising: a memory comprising executable instructions; and a processor configured to execute the executable instructions and cause the apparatus to perform a method in accordance with any one of Clauses 1-42.

Clause 44: An apparatus, comprising means for performing a method in accordance with any one of Clauses 1-42.

Clause 45: A non-transitory computer-readable medium comprising executable instructions that, when executed by a processor of an apparatus, cause the apparatus to perform a method in accordance with any one of Clauses 1-42.

Clause 46: A computer program product embodied on a computer-readable storage medium comprising code for performing a method in accordance with any one of Clauses 1-42.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communication by a first wireless communication device, comprising:
receiving control information from a network entity, the control information including:
scheduling information for one or more data channel transmissions; and
configuration information for one or more backscatter transmissions, by a second wireless communication device, corresponding to the one or more data channel transmissions;
receiving the one or more data channel transmissions from the network entity based on the scheduling information; and
receiving the one or more backscatter transmissions from the second wireless communication device.

2. The method of claim 1, wherein the configuration information includes at least one of:
a modulation type of the one or more backscatter transmissions,
a modulation order of the one or more backscatter transmissions,
a frequency domain resource allocation for receiving the one or more backscatter transmissions,
a time domain resource allocation for receiving the one or more backscatter transmissions, or
a square wave frequency of the one or more backscatter transmissions.

3. The method of claim 1, wherein:
the one or more backscatter transmissions comprise information included in the one or more data channel transmissions; and
the one or more backscatter transmissions are modulated to include additional information added by the second wireless communication device.

4. The method of claim 3, wherein the one or more backscatter transmissions are modulated using a same frequency band as the one or more data channel transmissions.

5. The method of claim 3, wherein the one or more backscatter transmissions are modulated using a different frequency band than the one or more data channel transmissions.

6. The method of claim 3, wherein the one or more backscatter transmissions are modulated based on a carrier frequency and a set of phase offsets indicated in the configuration information.

7. The method of claim 3, wherein the one or more backscatter transmissions are modulated based on a carrier frequency and an amplitude sequence indicated in the configuration information.

8. The method of claim 1, further comprising decoding the one or more backscatter transmissions received from the second wireless communication device based on the one or more data channel transmissions and the configuration information for the one or more backscatter transmissions.

9. The method of claim 1, further comprising transmitting, to the network entity, feedback information for the one or more data channel transmissions and the one or more backscatter transmissions.

10. The method of claim 9, wherein the feedback information comprises a joint hybrid automatic repeat request acknowledgement (HARQ-ACK) codebook, including feedback information for both the one or more data channel transmissions and the one or more backscatter transmissions.

11. The method of claim 9, wherein the feedback information comprises:
a first hybrid automatic repeat request acknowledgement (HARQ-ACK) codebook comprising first feedback information for the one or more data channel transmissions; and
a second HARQ-ACK codebook comprising second feedback information for the one or more backscatter transmissions.

12. The method of claim 9, wherein the feedback information for the one or more backscatter transmissions comprises positive feedback information, indicating that the one or more backscatter transmissions were properly received by the first wireless communication device.

13. The method of claim 12, further comprising:
receiving, from the network entity based on the positive feedback information, a grant allocating time and frequency resources for transmitting information decoded from the one or more backscatter transmissions to the network entity; and
transmitting the information decoded from the one or more backscatter transmissions to the network entity using the allocated time and frequency resources.

14. The method of claim 13, wherein the grant allocating time and frequency resources is received without first transmitting a scheduling request or a buffer status report to request time and frequency resources for transmitting the information decoded from the one or more backscatter transmissions.

15. The method of claim 9, wherein the feedback information for the one or more backscatter transmissions comprises negative feedback information, indicating that the one or more backscatter transmissions were not properly received by the first wireless communication device.

16. The method of claim 15, further comprising:
receiving, based on the negative feedback information, additional control information indicating that the one or more backscatter transmissions will be retransmitted by the second wireless communication device; and
receiving the one or more backscatter transmission retransmitted by the second wireless communication device based on the additional control information.

17. The method of claim 1, further comprising: transmitting, based on receiving the one or more backscatter transmissions, a scheduling request to the network entity to request time and frequency resources for transmitting information decoded from the one or more backscatter transmissions to the network entity.

18. The method of claim 17, further comprising:
receiving, from the network entity based on the scheduling request, a grant allocating time and frequency resources for transmitting the information decoded from the one or more backscatter transmissions to the network entity; and
transmitting the information decoded from the one or more backscatter transmissions to the network entity using the allocated time and frequency resources.

19. The method of claim 18, further comprising, based on transmitting the scheduling request, performing a buffer status report (BSR) procedure to report, to the network entity, an amount of data stored in a transmission buffer of the first wireless communication device associated with the information decoded from the one or more backscatter transmissions, wherein receiving the grant allocating the time and frequency resources is further based on the BSR procedure and the amount of data reported to the network entity.

20. The method of claim 1, further comprising:
receiving, based on a scheduling request not being transmitted by the first wireless communication device within a time window associated with transmission of the one or more data channel transmissions, additional control information indicating that the one or more backscatter transmissions will be retransmitted by the second wireless communication device; and
receiving the one or more backscatter transmissions retransmitted by the second wireless communication device based on the additional control information.

21. A method for wireless communication by a second wireless communication device, comprising:
receiving control information from a network entity, wherein the control information includes configuration information for one or more backscatter transmissions by the second wireless communication device;
receiving one or more data channel transmissions from the network entity; and
modulating the one or more data channel transmissions based on the configuration information to generate the one or more backscatter transmissions; and
transmitting, after modulating the one or more data channel transmissions, the one or more backscatter transmissions to a first wireless communication device.

22. The method of claim 21, wherein the configuration information includes at least one of:
a modulation type for the one or more backscatter transmissions,
a modulation order for the one or more backscatter transmissions,
a frequency domain resource allocation for transmitting the one or more backscatter transmissions,
a time domain resource allocation for transmitting the one or more backscatter transmissions, or
a square wave frequency for the one or more backscatter transmissions.

23. The method of claim 21, wherein the one or more backscatter transmissions comprise information included in the one or more data channel transmissions by the network entity as well as additional information added, based on the modulation, by the second wireless communication device.

24. The method of claim 21, wherein modulating the one or more data channel transmissions comprises modulating the one or more data channel transmissions using a same frequency band as the one or more data channel transmissions received from the network entity.

25. The method of claim 21, wherein modulating the one or more data channel transmissions comprises modulating the one or more data channel transmissions using a different frequency band than the one or more data channel transmissions received from the network entity.

26. The method of claim 21, wherein modulating the one or more data channel transmissions comprises modulating the one or more data channel transmissions based on based on a carrier frequency and a set of phase offsets indicated in the configuration information.

27. The method of claim 21, wherein modulating the one or more data channel transmissions comprises modulating the one or more data channel transmissions based on a carrier frequency and an amplitude sequence indicated in the configuration information.

28. The method of claim 21, further comprising:
harvesting energy from the one or more data channel transmissions; and
using the energy harvested from the one or more data channel transmissions to perform the modulating and the transmitting.

29. A first wireless communication device, comprising:
a memory comprising executable instructions; and
a processor configured to execute the executable instructions and cause the first wireless communication device to:
receive control information from a network entity, the control information including:
scheduling information for one or more data channel transmissions; and
configuration information for one or more backscatter transmissions, by a second wireless communication device,
corresponding to the one or more data channel transmissions;
receive the one or more data channel transmissions from the network entity based on the scheduling information; and
receive the one or more backscatter transmissions from the second wireless communication device.

30. A second wireless communication device, comprising:
a memory comprising executable instructions; and
a processor configured to execute the executable instructions and cause the second wireless communication device to:
receive control information from a network entity, wherein the control information includes configuration information for one or more backscatter transmissions by the second wireless communication device;
receive one or more data channel transmissions from the network entity; and
modulate the one or more data channel transmissions based on the configuration information to generate the one or more backscatter transmissions; and
transmit, after modulating the one or more data channel transmissions, the one or more backscatter transmissions to a first wireless communication device.
